(19) United States
(12) Patent Application Publication
(10) Pub. No.: US 2003/0202730 A1
(43) Pub. Date: Oct. 30, 2003

(54) Optical connection element and optical device having the same

(75) Inventors: Ichiro Fujieda, Tokyo (JP); Osamu Mikami, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION, CHAIR OF THE BOARD OF TRUSTEES TOKAI UNIVERSITY EDUCATIONAL SYSTEM

(21) Appl. No.: 10/422,788

(22) Filed: Apr. 25, 2003

(30) Foreign Application Priority Data
Apr. 25, 2002 (JP) 123909/2002

(51) Int. Cl. G02B 6/12; G02B 6/34

(52) U.S. Cl. 385/14; 385/37

(57) ABSTRACT

In an optical connection element having light guiding means which is capable of propagating light in a plurality of directions, input coupling means for inputting light from the outside to said light guiding means, and output coupling means for outputting light from said light guiding means to the outside, active-type optical means of which characteristics can be altered by control means is located in a path for transmitting light within said light guiding means.

### BACKGROUND OF THE INVENTION

The present invention relates to an optical connection element which is for use in optically connecting LSI chips to each other or modules including many LSI chips mounted thereon to each other, in particular to an optical connection element incorporating functions, such as optical branching, attenuation, separation of wave-length, separation of polarization of light, and the like. Further, the present invention also relates to an optical device which is constituted by arranging such an optical connection element or such a plurality of optical connection elements.

In order to rapidly transmit large-capacity data, opticalization of communication infrastructure has been progressed recently. As a result, optical techniques therefor have also been progressed. For example, optical fiber cables have been laid on the bottom of the sea. Further, in a base station, exchanges have been progressed to have large-capacity and high speed operation by a multiple wavelength communication technique or a rapid LSI technique.

Herein, a problem of electric wirings, “bottle neck of transmission speed”, has been conventionally recognized. The problem is that communication speed is restricted within an apparatus, such as a communication apparatus, a computer, and the like. Under the problem, even if electric signals would be able to be transmitted to every home by optical fibers, an user cannot take a sufficient benefit from broadband communication. Namely, the user cannot take such a sufficient benefit from the broadband communication, unless signal processing speed is enough high within the apparatus, such as the computer, and the like. The reason of the problem is that the electric signals cannot be transmitted at an enough high speed between LSI chips, such as CPU and memory or between modules, such as a mother board and a printed substrate including CPU mounted thereon, due to interference or propagation delay of the electric signals. On the other hand, there is another problem how we can make communication apparatus small in size at a low cost in “last one mile” from a base station to home. Large and expensive exchanges and the problem of communication apparatus in “last one mile” becomes a bar to FTTH (Fiber To The Home) concept that optical fibers are laid to every home.

Under the circumstances, an optical interconnection technique has come to be remarkable as a technique for solving the bottle neck of transmission speed and making a communication apparatus small in size at a low cost with a low electric power in “last one mile”. In the optical interconnection technique, signal transmission by electricity is replaced with signal transmission by light. The bottle neck of transmission speed caused from electric signals can be solved. In addition, freedom of designing connection patterns becomes large, for example, like a broadcasting-type connection. Further, in the optical interconnection technique, a component, such as an optical fiber, a connector, and the like can be mounted more compactly. Furthermore, wiring density can be more increased. Moreover, a transmission path can be analyzed more easily. Thereby, it is expected to be realized that a communication apparatus can be made small in size at a low cost with a low electric power.

As an example of the optical interconnection technique thus mentioned, an optical connection element using diffraction and refraction is disclosed in a paper Brenner. et al.(Karl-Heinz Brenner and Frank Sauer, “Diffractive-reflective optical interconnects”, Applied Optics, vol.27, No.20, pp.4251-4254, 1988.). In the optical connection element disclosed in the paper, a proceed of a light can be changed dynamically by irradiating a control light. The optical connection element is therefore capable of altering connection paths of light.

However, the conventional optical connection elements including one disclosed in the paper Brenner. et al., which are capable of altering connection paths of light, have the following problems.

First, it is necessary to irradiate a control light on a non-linear mirror to alter the connection paths of light. It therefore becomes necessary to prepare a source of light and control means for irradiating the control light. As a result, not only cost for manufacturing the optical connection device but also volume of the optical connection device are thereby increased.

Second, in a case that a control light is irradiated on a non-linear mirror to alter the connection paths of light, the light leaks out of the transparent substrate. This is enough for the optical connection element as a simple switch to change connection into non-connection, and non-connection into connection. Further, in order to use the optical connection element as a branching switch of a light, it is necessary to locate a component, such as a light receiving element, or the like in the direction of the proceed of the light having leaked from the transparent substrate. As a result, a cost for locating a new component is inevitably caused to occur. In addition, it takes increased time to mount the new component on an optical connection device. Accordingly, not only cost for manufacturing the optical connection device but also volume of the optical connection device are thereby increased.

Third, it is desired that the optical connection element has various functions in addition to the function for altering the connection paths of light. If so, it is not necessary that independent elements having these functions are added to the optical connection element. Then, the optical connection element has advantageous points that the optical device including the optical connection element becomes small in size and is manufactured at a reduced cost. Herein, the additional various functions are any one of functions among an optical attenuation function, that is, a function for attenuating a transmitted light down to a desirable level, a light quantity detecting function, that is, a function for detecting quantity of a transmitted light, a function of separation of wave-length, that is, a function for connecting different output destinations responsive to wave-length of each transmitted light, a function of separation of polarization of light, that is, a function for attenuation, detection, or separation of wave-length of only a specific polarization component included in a transmitted light. However, any proposals or suggestions are not made in the conventional optical connection technique about the points how these functions are provided to the optical connection element.

Fourth, any proposals or suggestions are also not made in the conventional optical connection technique about a method for forming a multi-channel optical device at a low cost by arranging plenty of optical connection elements.

### SUMMARY OF THE INVENTION

It is therefore an object of the present invention to provide an optical connection element which is for use in optically connecting LSI chips to each other or modules including many LSI chips mounted thereon to each other, in particular, to provide, at a low cost, an optical connection element incorporating functions, such as branching of light, attenuation of light, detecting of quantity of light, separation of wave-length of light, separation of polarization of light, and the like.

It is another object of the present invention to provide, at a low cost, an optical device using the optical connection element of the type described.

Other objects of the present invention will become clear as the description proceeds.

According to an aspect of the present invention, there is provided an optical connection element which is for use in optically connecting LSI chips to each other or modules including many LSI chips mounted thereon to each other, comprising:

light guiding means which is capable of propagating light in a plurality of directions;

input coupling means for inputting light from the outside to the light guiding means;

output coupling means for outputting light from the light guiding means to the outside;

active-type optical means which is located in a path for transmitting light within the light guiding means; and

control means which is capable of altering characteristics of said active-type optical means.

The active-type optical means is an active-type diffraction element including both a material having an opt-electrical effect and an electrode, the active-type optical means performing at least one function among the functions of optical branching, attenuation, separation of wave-length, and separation of polarization of light in response to an electric signal supplied from the control means.

The light guiding means is a transparent substrate, the active-type diffraction element having a liquid crystal located between a substrate and the transparent substrate.

The electrode has a shape like a pair of combs, the electrode being located in a surface of at least one of the substrate and the transparent substrate, the surface facing to the liquid crystal.

The electrode comprises a group of a plurality of periodically arranged electrode members, the electrode being located in a surface of at least one of the substrate and the transparent substrate, the surface facing to the liquid crystal.

The electrode is located uniformly in a surface of at least one of the substrate and the transparent substrate, the surface facing to the liquid crystal, a plurality of dielectrics being periodically located on or within the liquid crystal.

The control means comprises a circuit element including a thin-film transistor in a surface of the transparent substrate, the surface facing to the liquid crystal.

At least one of the input coupling means and the output coupling means is composed of a diffraction element or a reflection element located within the light guiding means.

According to another aspect of the present invention, there is also provided an optical device comprising:

at least one light emitting element;

a plurality of light receiving elements; and

an optical connection element;

the optical connection element including:

light guiding means which is capable of propagating light in a plurality of directions;

input coupling means for inputting light from the outside to the light guiding means;

output coupling means for outputting light from the light guiding means to the outside;

active-type optical means which is located in a path for transmitting light within the light guiding means; and

control means which is capable of altering characteristics of said active-type optical means.

The light guiding means is a transparent substrate, at least either one of the light emitting element and the light receiving elements are flip-chip mounted on the transparent substrate.

The light emitting element and the light receiving elements are flip-chip mounted on a printed substrate having a plurality of openings, a light from the light emitting element being lead to the input coupling means through the a plurality of openings while a light from the output coupling means being lead to the light receiving elements through the a plurality of openings.

The refraction elements each having a light gathering function are located between the light emitting element and the input coupling means, between the output coupling means and the light receiving elements, respectively.

The light quantity detecting means for monitoring quantity of light transmitted within the light guiding means are located in the path for transmitting light within the light guiding means.

The light quantity detecting means is a light receiving element including an amorphous silicon material.

### BRIEF DESCRIPTION OF THE DRAWINGS

FIG. 1 is an explanation view for showing a constitution of an optical device using a conventional optical connection element;

FIG. 2 is an explanation view for showing a constitution of an optical device using a conventional optical connection element;

FIG. 3 is an explanation view for schematically showing a constitution of the optical device using the optical connection element according to the first embodiment of the present invention;

FIG. 4 is an explanation view for schematically showing a section of the optical device illustrated in FIG. 3 including main components and principles of operation thereof;

FIG. 5 is a view, taken from the side of the transparent substrate, for showing components of the optical device illustrated in FIG. 3 located under the transparent substrate;

FIG. 6 is an explanation view for schematically showing an operation of the optical device using the optical connection element according to the first embodiment of the present invention;

FIG. 7 is an explanation view for schematically showing an operation of the liquid crystal diffraction element used as an active-type diffracting means of the optical connection element according to the first embodiment of the present invention;

FIG. 8 is a sectional view for showing the liquid crystal diffraction element 170 including the electrode shaped like the teeth of a comb illustrated in FIG. 7;

FIG. 9 is a conceptual view for showing a condition that a light is input from an end surface of the upper transparent substrate in this liquid crystal diffraction element;

FIG. 10 is a photograph for showing a condition that a light has been input to the liquid crystal diffraction element fabricated for trial;

FIG. 11 is an explanation view for schematically showing characteristics of the liquid crystal diffraction element according to the first embodiment of the present invention;

FIG. 12 is an explanation view for schematically showing operations of the liquid crystal diffraction element according to the first embodiment of the present invention;

FIG. 13 is a photograph for schematically showing operations of the liquid crystal diffraction element according to the first embodiment of the present invention;

FIG. 14 is an explanation view for showing main components of the optical device according to the second embodiment of the present invention;

FIG. 15 is an explanation view for showing a constitution of the common control circuit;

FIG. 16 is a view for showing an example of a constitution of an optical device having such a light quantity detecting function;

FIG. 17 is an explanation view for showing the constitution of the control circuit;

FIG. 18 is a view for showing an example of constitution of an optical device including such a variable attenuating function of light quantity;

FIG. 19 is an explanation view for showing the constitution of the control circuit;

FIG. 20 is an explanation view for showing a section including main components and principles of operations in the optical device using such a method of mounting;

FIG. 21 is an explanation view for showing main components located under the printed substrate 81 in the optical device of FIG. 20;

FIG. 22 is an explanation view for showing a section including main components and principles of operations in the optical device having such a constitution;

FIG. 23 is an explanation view for showing a section including main components and principles of operations in the optical device using reflection elements as input and output coupling means; and

FIG. 24 is a view for showing, as an eighth embodiment of the present invention, the remaining combination, that is, a constitution in which light emitting elements, and the like are mounted on a transparent substrate and the diffraction elements are formed above the transparent substrate.

### DETAILED DESCRIPTION OF THE PREFERRED EMBODIMENTS

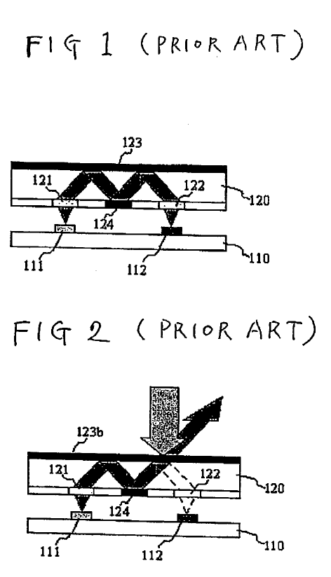

Referring to FIG. 1, description is, at first made about a conventional optical connection element disclosed in the paper Brenner. et al. in order to facilitate an understanding of the present invention. FIG. 1 shows a constitution of the optical connection element.

As illustrated in FIG. 1, the optical connection element comprises a substrate 110 and a transparent substrate 120. A light emitting element 111 and a light receiving element 112 are mounted on one surface of the substrate 110. A diffraction element 121, a diffraction element 122 are located at positions facing to the light emitting element 111, the light receiving element 112, respectively, on the transparent substrate 120. Further, a mirror 123 and a mirror 124 are formed on surfaces opposite to each other of the transparent substrate 120. With the structure illustrated in FIG. 1, the diffraction element 121 renders a light from the light emitting element 111 to be a parallel light by collimating the light and then deflects the parallel light in a predetermined direction. The light is transmitted in the transparent substrate 120 with being reflected by the mirror 123 and the mirror 124 to reach the diffraction element 122. Contrary to the diffraction element 121, the diffraction element 122 deflects the parallel light and then gather the light to the light receiving element 112. Thus, the light is reflected by the mirrors several times and thereby a proceed of the light is folded within the transparent substrate 120. Thereby, signal transmission can be realized from the light emitting element 111 to the light receiving element 112. Herein, instead of the diffraction element having a collimating function, a diffraction element having a light gathering function can be used so that a light emitted from the light emitting element 111 may be gathered and received by the light receiving element 112.

In the optical connection element illustrated in FIG. 1, the light is transmitted through the three-dimensional space within the transparent substrate 120. In such a “free space” within the transparent substrate 120, a plurality of optical signals can be transmitted through the same path, when the light are not interfered with each other. As a result, an optical connection with high density is available. A freedom of design is also available. These are large merits of the three-dimensional optical connection technique, compared with a planar optical connection technique using optical waveguides.

However, a proceed of light depends on characteristics of a diffraction element and a light emitting element used in the optical connection technique. Once connection paths have been determined, the connection paths cannot be altered thereafter. However, it is sometimes desired to alter the connection paths, dependent on applications of the optical connection technique. For example, it is desired to alter the connection paths, dependent on time. Further, when a connection path comes to be unable to be used, it is desired to change the connection path into another connection path. If an optical switch is located instead of the light receiving element illustrated in FIG. 1, the connection path can be altered. However, if such an independent element is used, it takes increased time to mount components on an optical connection device. Further, not only cost for manufacturing the optical connection device but also volume of the optical connection device are thereby increased. Thus, it is not desirable that the optical switch is located instead of the light receiving element illustrated in FIG. 1. A constitution for solving this problem is disclosed in the above-mentioned paper, Brenner et al. Namely, as illustrated in FIG. 2, a non-linear mirror 123b formed by a non-linear material is used, instead of the mirror 123 in FIG. 1. Herein, the non-linear mirror 123b is capable of dynamically changing its condition, from transmitting condition into reflecting condition, from reflecting condition into transmitting condition, each other. When a control light is irradiated on the non-linear mirror 123b, the non-linear mirror 123b becomes the transmitting condition. As a result, a light transmitted within the transparent substrate 120 escapes the transparent substrate 120 to the outside thereof, so that the light does not reach the diffraction element 122 and also the light receiving element 112. Accordingly, a proceed of a light can be changed dynamically, dependent on existence of the control light. Although, it is not disclosed in the above-mentioned paper, Brenner et al., a light receiving element can alternatively be located in the direction of the transmitted light having escaped the transparent substrate 120 to the outside thereof. With the alternative structure, it is apparent that the optical connection element functions as a branching switch of a light.

However, the optical connection element disclosed in the paper Brenner. et al. has the first through the fourth problems mentioned in the preamble of the instant specification.

[First Embodiment]—Branching, Attenuation, Separation of Wave-Length, Separation of Polarization of Light—

Now, referring to FIGS. 3 through 13, description will proceed to an optical connection element and an optical device using the optical connection element according to a first embodiment of the present invention. FIG. 3 is an explanation view for schematically showing a constitution of the optical device using the optical connection element according to the first embodiment of the present invention.

As illustrated in an exploded perspective view positioned at the right hand of the sheet of FIG. 3, the optical device comprises a transparent substrate 11, a substrate 42, a light emitting element 60 and light receiving elements 70a, 70b, 70c which are mounted on an upper surface of the transparent substrate 11, diffraction elements 21, 31, 32, 33 located on an upper surface of the substrate 42, an electrode 43 shaped like the teeth of a comb and a control circuit 51 formed on the upper surface of the substrate 42, and a liquid crystal 41 inserted between the substrate 42 and the transparent substrate 11.

The transparent substrate 11 is actually formed by a glass material or a polymer material, such as PMMA, PCB, and the like. An wiring 12 is formed on the upper surface of the transparent substrate 11 on which the light emitting element 60 and the light receiving elements 70a, 70b, 70c are mounted. The light emitting element 60 and the light receiving elements 70a, 70b, 70c are electrically connected to an external circuit (not shown) by the wiring 12. The diffraction elements 21, 31, 32, 33 are formed on positions of the upper surface of the substrate 42 facing the light emitting element 60, the light receiving elements 70a, 70b, 70c, respectively.

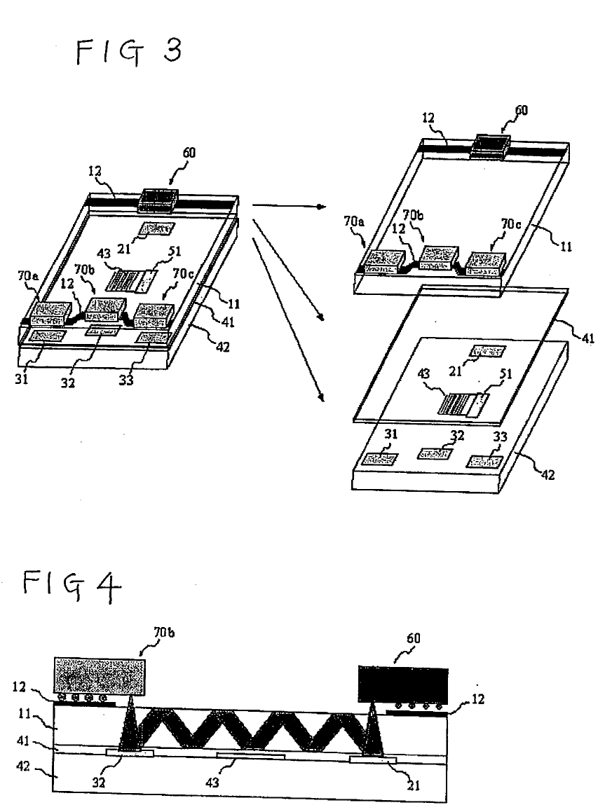

FIG. 4 is an explanation view for schematically showing a section of the optical device illustrated in FIG. 3 including the light emitting element 60, the light receiving element 70b, and the like. In this example, illustrated are the light emitting element 60, the light receiving element 70b, and the like are flip-chip mounted on the transparent substrate 11. Namely, the light emitting element 60, the light receiving element 70b, and the like are fixed on the wiring 12 formed on the transparent substrate 11 using solders, or the like, and thereby electrically connected to an external circuit. Further, FIG. 5 is a view, taken from the side of the transparent substrate 11, for showing components of the optical device illustrated in FIG. 3 located under the transparent substrate 11. Besides, in FIGS. 4 and 5, illustrated is a path of the light emitted from the light emitting element and reached the light receiving element.

Referring to FIGS. 3 through 5, description proceeds to an operation of the optical device illustrated in FIG. 3.

A light emitted from the light emitting element 60 transmits through the transparent substrate 11 and the liquid crystal 41 one by one to reach the diffraction element 21. Herein, responsive to directivity of the light emitting element 60, the light reached the diffraction element 21 has a spreading to some extent. When the diffraction element 21 reflects the light, the diffraction element 21 not only converts the spread light into a parallel light but also changes the proceed of the light. Thus, the light collimated and deflected simultaneously by the diffraction element 21 is then transmitted within the transparent substrate 11 with being reflected repeatedly inside the transparent substrate 11. In this example, a material having a high refractive index is used as the transparent substrate 11. As a result, the light is adjusted to be reflected totally by upper and lower inner surfaces of the transparent substrate 11, so that the light is transmitted within the transparent substrate 11. Alternatively, reflecting materials may be located at positions of the upper and the lower inner surfaces of the transparent substrate 11 that the light reaches, so that the light is transmitted within the transparent substrate 11. The transmitted light soon reaches an area in which the electrode 43 shaped like the teeth of a comb is formed.

Herein, when a voltage is supplied to the electrode 43 shaped like the teeth of a comb by the control circuit 51, a refractive index of the liquid crystal 41 located above the electrode 43 shaped like the teeth of a comb is varied. As a result, periodical patterns of the refractive index are generated, responsive to the electrode 43 shaped like the teeth of a comb. Since medium having periodical variation of the refractive index functions as a diffraction element, the light is branched to a plurality of directions by diffraction. In this example, the light is branched to three directions by diffraction.

These branched lights, as mentioned above, are transmitted within the transparent substrate 11 with being reflected repeatedly inside the transparent substrate 11. The branched light then reaches the diffraction elements 31, 32, 33. These diffraction elements 31, 32, 33 change the proceed of the branched light in the directions of the light receiving elements 70a, 70b, 70c located at positions corresponding to the diffraction elements 31, 32, 33, respectively. At the same time, these diffraction elements 31, 32, 33 gather the branched light on each light receiving portion of the light receiving elements 70a, 70b, 70c.

By the operation thus mentioned, in a case that a voltage is supplied to the electrode 43 shaped like the teeth of a comb, the light emitting element 60 is optically connected to the light receiving elements 70a, 70b, 70c, respectively.

On the other hand, in a case that a voltage is not supplied to the electrode 43 shaped like the teeth of a comb, alignment of liquid crystal molecules remains uniform. As a result, periodical distribution of the refractive index is not generated. The light is therefore transmitted within the transparent substrate 11 without being branched. The light reaches the diffraction element 32 and then entered into the light receiving element 70b. Accordingly, in this case, the light emitting element 60 is optically connected to the light receiving element 70b.

Thus, by the control circuit 51, it can be controlled whether or not the periodical distribution of the refractive index is generated in a specific position of the liquid crystal 41. Thereby, connection paths of light can be changed. Accordingly, the constitution illustrated in FIG. 3 through FIG. 5 is an optical connection element having a function for branching of light.

Herein, diffraction angle depends on wave-length of light. In a case that an incident light includes a plurality of wave-lengths like multiple wave-length communication technique, a plurality of wave-lengths can be divided (separated) by this optical connection element to be connected with light-receiving elements corresponding to each wave-length, respectively. Accordingly, the constitution illustrated in FIG. 3 through FIG. 5 is the optical connection element having also a function for separation of wave-length.

Further, as will be described more in detail, when a voltage applied to the electrode 43 shaped like the teeth of a comb is varied, intensity of diffracted light is also varied. For example, let pay attention to the connection with the light receiving element 70b to which non-diffracted light is connected. It can be understood that the optical connection element functions as a variable optical attenuator (VOA) for attenuating an incident light down to an optional intensity. Accordingly, the constitution illustrated in FIG. 3 through FIG. 5 is the optical connection element having also the function of VOA. However, when the optical connection element is rendered to function as VOA, it is required that unnecessary light is absorbed. This can be readily achieved, for example, by forming light absorbing layers instead of the diffraction elements 31, 33, and so on.

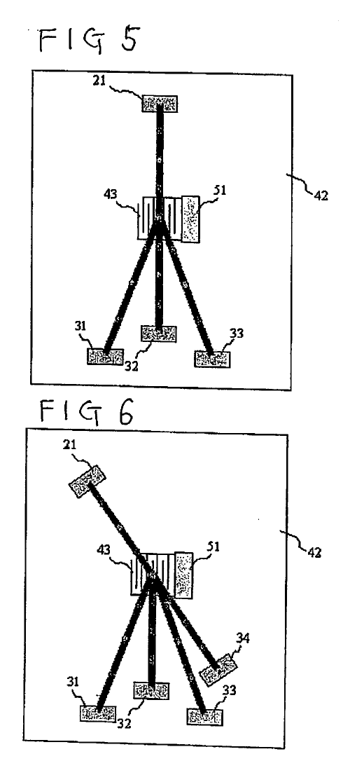

The above description was made about a case that a direction of the teeth of the comb of the electrode 43 shaped like the teeth of a comb is parallel to a direction of the incident light in a plan view of FIG. 5. FIG. 6 shows an example of another case that the direction of the teeth of the comb of the electrode 43 shaped like the teeth of a comb is not parallel to the direction of the incident light. With this structure illustrated in FIG. 6, when a voltage is not supplied to the electrode 43 shaped like the teeth of a comb, a light goes straight to reach the diffraction element 34. On the contrary, when a voltage is supplied to the electrode 43 shaped like the teeth of a comb, a diffracted light is generated in a direction parallel to the direction of the teeth of the comb of the electrode 43 shaped like the teeth of a comb in a plan view of FIG. 6. Further, as will be described after, one of polarization components of the incident light can be diffracted while another one of polarization components of the incident light can go straight. Accordingly, the constitution illustrated in FIG. 6 is the optical connection element having also a function for separation of polarization of light.

The component having the most remarkable and important function is “active-type diffraction element” that is composed of, the substrate 42 having the electrode 43 shaped like the teeth of a comb formed thereon, the transparent substrate 11, and the liquid crystal 41 interposed between the substrate 42 and the transparent substrate 11.

Hereunder, with an example using a vertically aligned liquid crystal diffraction element, detailed description will be made as regards actually manufacturing an optical connection device for trial and a result of estimating characteristics of the manufactured optical connection device.

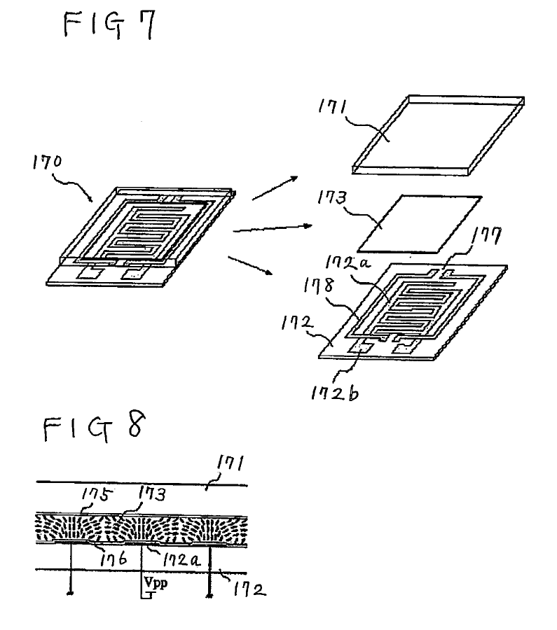

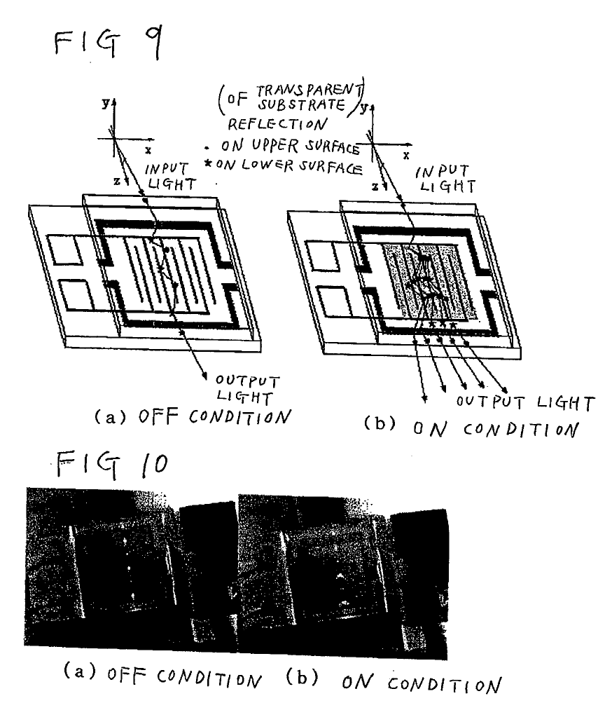

FIG. 7 is an explanation view for showing a constitution of a liquid crystal diffraction element used as the active-type diffraction element. In FIG. 7, illustrated is the liquid crystal diffraction element 170. As illustrated in an exploded perspective view positioned at the right hand of the sheet of FIG. 7, the liquid crystal diffraction element 170 comprises a transparent substrate 171, a substrate 172 on which a transparent electrode 172a is formed, and a liquid crystal 173 interposed between the transparent substrate 171 and the substrate 172. The transparent electrode 172a has pad portions 172b formed on the substrate 172. The transparent electrode 172a is electrically connected to the outside by way of the pad portions 172b.

FIG. 8 is a sectional view for showing the liquid crystal diffraction element 170 illustrated in FIG. 7. As illustrated in FIG. 8, alignment films 175, 176 are formed on surfaces of the transparent substrate 171 and the substrate 172 each facing the liquid crystal 173, respectively. Further, as illustrated in the exploded perspective view of FIG. 7, a liquid crystal sealing gate 177 and a sealing material 178, both of which is for injecting the liquid crystal to be sealed, are formed on the substrate 172. Herein, in order that the transparent substrate 171 may function as light guiding means, it is important to determine each refractive index of the transparent substrate 171, the substrate 172, and the liquid crystal 173.

Hereunder, with concrete examples of numeric data, detailed description will be made about a method of fabricating a liquid crystal diffraction element according to this embodiment and characteristics thereof. In Table 1, depicted are members mainly used for the fabrication of the liquid crystal diffraction element.

TABLE 1
Members used for fabricating liquid crystal diffraction element

member

| | |
|---|---|
| transparent | glass substrate made by Sumita optics.Co.Ltd. |
| substrate | polishing member: LaF70 n = 1.74950 |
| | size 140 mm × 140 mm, thickness 1.1 mm |
| liquid crystal | made by Merc.Japan.Co.Ltd. type name: BDH-TL213 |
| | ne = 1.7659, no = 1.5271, permittivity |
| | anisotropic |
| | Δε = 5.7 |
| electrode shaped | material: ITO, thickness 100 mm |
| like the teeth of | pattern: width 5 μm, arrangement pitch |
| a comb | 10 μm, area 15 mm × 15 mm, |
| substrate | glass substrate made by Nippon Denki Glass. Co.Ltd. |
| | type name: OA-10 n = 1.52, |
| | size 150 mm × 150 mm, thickness 0.7 mm |

Herein, the transparent substrate 171 functioning as light guiding means was made of a material having, especially, a high refractive index. The liquid crystal is formed by a nematic liquid crystal while the substrate is formed by a glass substrate of no alkaline. Both of the nematic liquid crystal and the glass substrate of no alkaline are such members as generally used for manufacturing a liquid crystal display. In order to form the electrode shaped like the teeth of a comb, at first, an ITO (Indium Tin Oxide) film having a thickness of 100 nm is formed on the substrate. The ITO film is then subjected to patterning by a photolisography to form the electrode shaped like the teeth of a comb. In this liquid crystal diffraction element, a width, an arrangement pitch of the electrode shaped like the teeth of a comb are 5 μm, 10 μm, respectively. The substrate thus used has an area of 150 mm×150 mm. In one substrate, nine electrode patterns for the electrode shaped like the teeth of a comb are formed at the same time. Thereafter, nine liquid crystal diffraction elements are separated from one substrate.

In Table 2, depicted are actual fabrication processes. A material of the alignment film used herein is such one that the liquid crystal is vertically aligned against the alignment film, when no voltage is applied to the liquid crystal. It is not required that surface processing like a rubbing processing, a diagonal vapor deposition of a material, such as SiO, and the like are conducted. A distance between the two substrates, the transparent substrate and the substrate, that is, a thickness of the liquid crystal layer after the liquid crystal is injected therebetween, is determined to be 6 μm by selecting both a spacer mixed in the sealing material and a spacer spread over the substrate. These processes are such ones as generally used for manufacturing a liquid crystal display.

TABLE 2
Actual fabrication processes of liquid crystal diffraction element

| process | | contents |
|---|---|---|
| 1 | Forming alignment film | olyimide are spin-coated on both the electrode substrate and the opposite |
| | | substrate. The electrode substrate and the opposite substrate are then |
| | | subjected to firing. |
| 2 | Rubbing processing | unnecessary |
| 3 | Applying sealing material | A sealing material including rod-shaped spacers each having a diameter of |
| | | 6 μm is coated on the electrode substrate. The electrode substrate is |
| | | then subjected to transient firing. |
| 4 | Spreading spacer material | Spacers each having a diameter of 6 μm is spread on the opposite substrate |
| 5 | Sticking to each other | The electrode substrate and the opposite substrate are sticked to each other |
| | | and then heated with a load being added thereto |
| 6 | Measuring a distance | The distance was 5 μm in a cell positioned at central of both the substrates |
| | between the electrode | while the distance was 6 μm in circumferential portions |
| | substrate and the | |
| | opposite substrate | |
| 7 | Cut the substrates | Nine liquid crystal diffraction elements are separated from one substrate |
| 8 | Liquid crystal injection | A liquid crystal is injected from a liquid crystal sealing gate by capillarity |
| 9 | Sealing the gate | UV hardened resin is used for sealing the gate |
| 10 | Polishing end surfaces | End surfaces through which light is input and output are polished to be |
| | | mirror surfaces |
| 11 | Connecting lead wire | Lead wires are connected to the pad portions by solders using ultrasonic |
| | | soldering |

Referring to FIGS. 8 through 13, description proceeds to an operation of the liquid crystal diffraction element fabricated in line with the processes described above.

FIG. 8 is a sectional view for showing the liquid crystal diffraction element 170 including the electrode shaped like the teeth of a comb illustrated in FIG. 7. In FIG. 8, liquid crystal molecule is conceptually depicted by an ellipsoid. Namely, refractive index of liquid crystal molecule is anisotropic. A refractive index ne with respect to abnormal light is represented by a major axis of the ellipsoid while a refractive index no with respect to normal light is represented by a minor axis of the ellipsoid. Of course, the liquid crystal molecule is far smaller than the transparent electrode. FIG. 8 does not show actual size and shape of the liquid crystal molecule. FIG. 8 depicts a case that a voltage is applied to the electrode shaped like the teeth of a comb (transparent electrode). The liquid crystal molecules are aligned substantially perpendicular to the substrates above the electrode shaped like the teeth of a comb (transparent electrode). On the contrary, the liquid crystal molecules are aligned substantially parallel to the substrates between the adjacent electrodes (transparent electrodes). Herein, considering a light transmitted within the upper transparent substrate, when the light reaches an area of the liquid crystal having periodical refractive index distribution, the light is diffracted to change a proceed thereof On the other hand, in a case that a voltage is not applied to the electrode shaped like the teeth of a comb (transparent electrode), the liquid crystal molecules are uniformly aligned perpendicular to the alignment film. As a result, the periodical refractive index distribution is not generated in the liquid crystal. Consequently, the light transmitted within the upper transparent substrate is not diffracted, when the light reaches an area in which the electrode shaped like the teeth of a comb (transparent electrode) is located. Accordingly, a proceed of the light can be changed, dependent on whether or not a voltage is applied to the electrode shaped like the teeth of a comb (transparent electrode). Further, since diffraction angle depends on wave-length of the light, a light having each (respective) wave-length can be separated from the light including a plurality of wave-lengths.

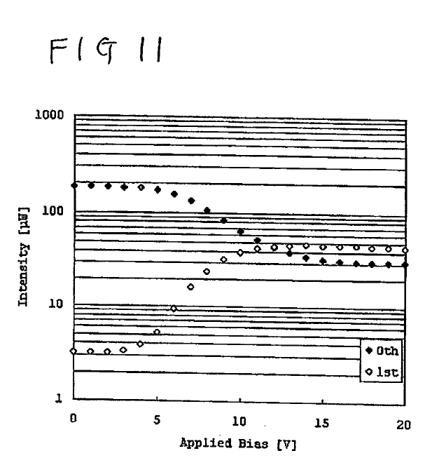

FIG. 9 conceptually shows a condition that a light is input from an end surface of the upper transparent substrate in this liquid crystal diffraction element. Each refractive index of the transparent substrate or the liquid crystal, an angle of the incident light are determined, respectively, in order that the light may be transmitted within the transparent substrate with being totally reflected repeatedly inside the transparent substrate. An laser diode is used as a light source, by which a single colored light having a wave-length of 670 nm is input from an end surface of this liquid crystal diffraction element. A polarizer is inserted between the light source and the liquid crystal diffraction element. Only one of polarization component of light is adjusted to be input. However, an incident plane of the light is the y-z plane of FIG. 9. In addition, the incident plane of the light has a certain angle from the z-x plane of FIG. 9.

FIG. 10 is a photograph for showing a condition that a light has been input to the liquid crystal diffraction element fabricated for trial. At first, a polarized light (hereunder called TM wave) of a component of which amplitude direction of electric field is perpendicular to the transparent electrode is input to the liquid crystal diffraction element. In this case, when a voltage is applied to the electrode shaped like the teeth of a comb, plenty of diffracted light is generated with the direction of the incident light being central, as shown in a photograph of FIG. 10(b). These diffracted light is output through another end surface of the liquid crystal diffraction element to the outside of the transparent substrate. On the other hand, when a voltage is not applied to the electrode shaped like the teeth of a comb, little diffracted light is generated, as shown in a photograph of FIG. 10(a). As a result, the light, as it stands, is transmitted within the transparent substrate and then output from the end surface of the liquid crystal diffraction element. Herein, bright points can be confirmed in the upper transparent substrate in photographs of FIG. 10. This is because a part of the light reached the liquid crystal layer is scattered by the liquid crystal layer. Further, intensity of these bright points changes alternately. The reason can be considered to be that a part of the light transmitted within the transparent substrate is weakly scattered by an alien attached to an upper surface of the transparent substrate.

Next, on the other hand, a polarized light (hereunder called TE wave) of a component of which amplitude direction of electric field is parallel to the transparent electrode is input to the liquid crystal diffraction element. In this case, even though a voltage is (or is not) applied to the electrode shaped like the teeth of a comb, little diffracted light is generated to show a result similar to that of FIG. 10(a).

Further, each intensity of the light output from end surface of the transparent substrate is measured by a power meter, when the voltage applied to the electrode shaped like the teeth of a comb is varied. The result is shown in a graph of FIG. 11. As will be understood from the graph of FIG. 11, it can be confirmed that an intensity of the 0-th diffracted light (namely, non diffracted component) is reduced as the voltage applied to the electrode shaped like the teeth of a comb is increased. On the other hand, the first diffracted light acts contrary to this. As depicted in FIG. 11, when the voltage applied to the electrode shaped like the teeth of a comb is a certain value (about 12 V), an intensity of the 0-th diffracted light becomes equal to that of the first diffracted light. Accordingly, the result of FIG. 11 suggests that light having the same intensity are transmitted in three directions.

The results of these experiments can be understood as follows.

At first, while the voltage applied to the electrode shaped like the teeth of a comb is small, almost liquid crystal molecules remain being uniformly aligned perpendicular to the transparent substrate. As a result, a refractive index distribution of the liquid crystal layer is uniform. However, there is periodicity dependent on whether or not the transparent electrode shaped like the teeth of a comb exists, a weak diffracted light is generated. In FIG. 11, when no voltage is applied to the electrode shaped like the teeth of a comb, it is observed that the first diffracted light having intensity approximately one fifteenth as large as that of the 0-th diffracted light. This is caused by an influence of the transparent electrode thus located periodically.

Next, with the applied voltage being increased, an electric field having a sufficient intensity comes to exist in regions between the transparent electrodes. The liquid crystal molecules in the regions are thereby aligned in the direction of the electric field. An intensity of the electric field is weak in regions directly above the transparent electrode. The liquid crystal molecules in the regions directly above the transparent electrode thereby remain aligned in the perpendicular direction. On the other hand, the liquid crystal molecules cannot change their alignment condition in regions near the alignment film by the strong influence from the alignment film, even if an intensity of the electric field is large enough in the regions near the alignment film. However, with the applied voltage being increased, the regions having the periodicity of the refractive index distribution expand up to the upper portion of the transparent substrate. As a result, a light transmitted within the transparent substrate becomes sensitive to the periodicity of the refractive index distribution.

The above operation thus mentioned is applied to a case that a light input to the transparent substrate is TM wave. As mentioned before, in a case of the TE wave, even if any voltage is (or is not) applied, little diffracted light is generated. The reason can be considered to be that the TE wave is totally reflected by a liquid crystal layer having the liquid crystal molecules aligned in the perpendicular direction near the substrate, so that the TE wave cannot be absorbed to a liquid crystal layer having the liquid crystal molecules aligned periodically. Accordingly, this element has a dependency on polarization of light. The element can be operable as a polarization isolator which diffracts only a specific polarization component of the light.

Besides, in FIG. 10(b), a region of approximately 15 mm×15 mm in which the electrode shaped like the teeth of a comb is located looks white. The reason is that a room light is scattered by the liquid crystal molecules aligned periodically. In an actual use, any light other than signal light is prevented from entering the transparent substrate by means that the element, as a whole, is inserted into a sealed container, or the like.

Further, dependent on a design of the liquid crystal diffraction element, plenty of diffracted light of higher order are sometimes generated, as illustrated in FIG. 10(b). If unnecessary diffracted light is transmitted within the transparent substrate, the unnecessary diffracted light is reflected on an interface existing in a boundary of the liquid crystal diffraction element. Further, a diffracted light is newly generated due to non-perfection of the diffraction element used for input and output coupling. As a result, the unnecessary diffracted light or the newly generated diffracted light becomes stray light. Further, such stray light turns out to be noise, when the stray light arrives at the light receiving element. However, not only angles generating such unnecessary and new diffracted light but also the positions of the surface of the transparent substrate at which the unnecessary and new diffracted light arrive can be previously prospected. Therefore, unnecessary diffracted light which is not used for optical connection can be absorbed by previously forming a light absorbing material on the surface of the transparent substrate. Thereby, noise due to the unnecessary diffracted light can be prevented from being mixed into the liquid crystal diffraction element.

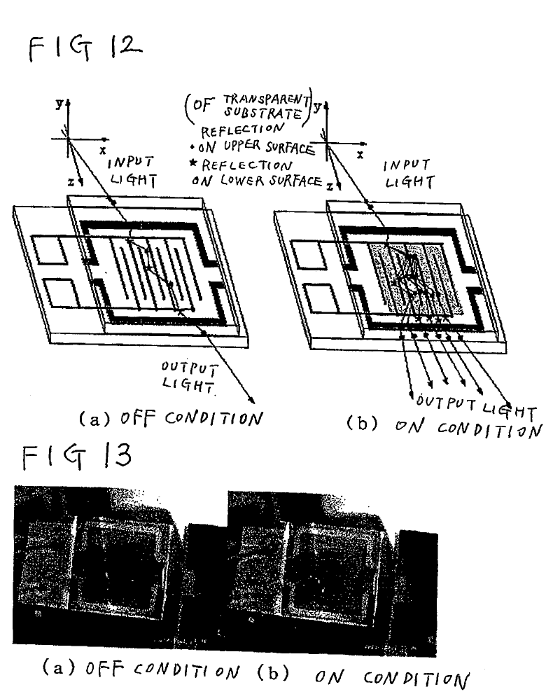

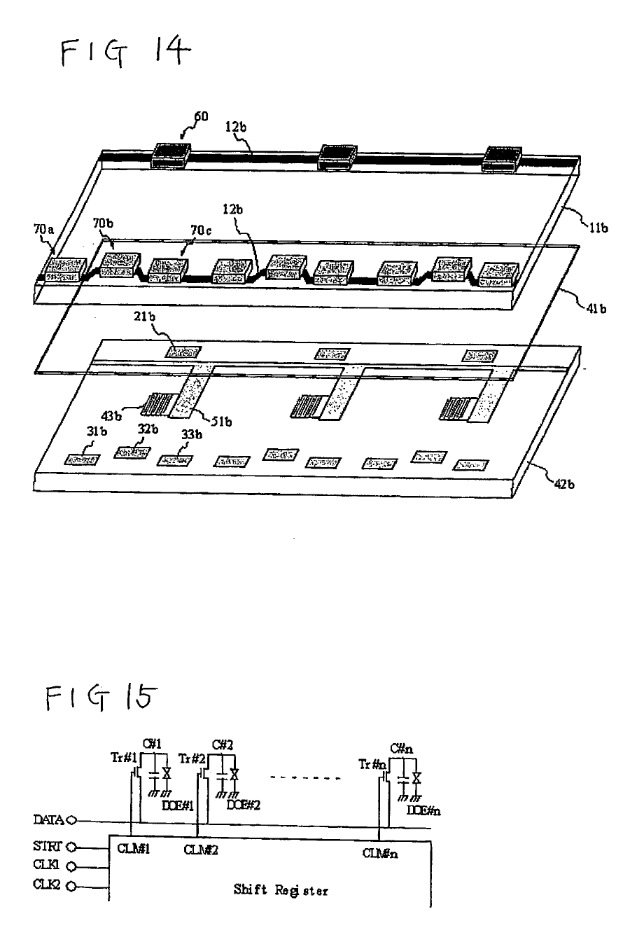

Next, although an incident plane of the light exists y-z plane in FIGS. 9 and 10, the light can alternatively be entered into the liquid crystal diffraction element, as illustrated in FIG. 12, not from the y-z plane. FIG. 13 is a photograph for showing the liquid crystal diffraction element fabricated for trial to which a light (TM wave) is thus entered. When a voltage is applied to the electrode shaped like the teeth of a comb, plenty of diffracted light are generated symmetrically with a central direction parallel to the teeth of a comb of the electrode, as shown in a photograph of FIG. 13(b). These diffracted lights are output to the outside of the transparent substrate from another end surface of the liquid crystal diffraction element. On the other hand, when a voltage is not applied to the electrode shaped like the teeth of a comb, little diffracted light is generated, as shown in a photograph of FIG. 13(a). The light, as it stand, is transmitted within the transparent substrate and is output from an end surface of the liquid crystal diffraction element. Accordingly, in a case that a light having a random direction of polarization is entered into the liquid crystal diffraction element, TE wave goes straight while TM wave is diffracted. The TM wave is thus diffracted, so that a proceed of the TM wave is changed. Thus, the light having the random direction of polarization is separated or branched by the liquid crystal diffraction element.

As described above, since an optical connection element according to the present invention includes functions of optical branching, separation of wave-length, separation of polarization of light, the optical connection element can be applied to an optical device for which these functions are required. Such an optical device is hereunder described.

First, in this optical connection element, as illustrated in FIG. 11, an intensity of the 0-th diffracted light can be adjusted by a voltage applied thereto. Accordingly, the constitution of FIG. 3 is equal to a constitution that the light emitting element 60 and the light receiving element 70b are connected to each other by a variable optical attenuator. In the example illustrated in FIG. 5, a ratio of the minimum value to the maximum value of the 0-th diffracted light is approximately 6. The ratio can be determined to be a large value, if necessary, by designing distribution of electric field and selecting a material of liquid crystal. Further, as will be described, if a plurality of similar liquid crystal diffraction elements are connected in series, attenuating amount can be enlarged.

Second, a plurality of diffracted light are used as an output, as illustrated in FIG. 3, an optical connection element according to the present invention is operable as a branching switch having also a function of variable optical attenuation.

Third, when light of a plurality of wave-lengths different from each other are included in an incident light, each light having each wave-length can be separated from the other light. This uses a fact that diffraction angle depends on wave-length. Therefore, an optical connection element according to the present invention is operable as a branching filter or a filter capable of connecting a light of a specific wave-length to the output side.

Fourth, in a case that a light having a random direction of polarization is entered into the optical connection element according to the present invention, TE wave goes straight while TM wave is diffracted and so separated. Therefore, an optical connection element according to the present invention functions as a polaroid separation filter.

[Variations of the First embodiment]

In the first embodiment of the present invention described above, description was made about an example in which the liquid crystal molecules are aligned perpendicular to the transparent substrate without applying a voltage thereto. The alignment direction of the liquid crystal molecules is not restricted to this example. Similar to those generally conducted in the conventional examples, the liquid crystal molecules may be aligned parallel to the transparent substrate without applying a voltage thereto while the liquid crystal molecules may be aligned perpendicular to the transparent substrate with applying a voltage thereto. Alternatively, at first, the liquid crystal molecules may be aligned parallel to the direction in which the electrode is aligned while the liquid crystal molecules may be aligned perpendicular to the direction in which the electrode is aligned at the time a voltage is applied thereto. Such alignment direction of the liquid crystal molecules can be determined freely, for example, by selecting a direction of rubbing processing. Accordingly, the other constitutions using the alignment direction of the liquid crystal molecules thus mentioned are deemed to be variations of the first embodiment of the present invention.

Further, size, a kind of material, manner for mounting, and the like of various components of the first embodiment may be selected as far as it is within the scope of the present invention. For example, size of the electrode or liquid crystal layer is design matter. The size is not restricted to an example of value thereof in this embodiment. Furthermore, a method of injecting liquid crystal may be such one that does not utilize capillarity like a coating method. A liquid crystal of polymer property may be formed by spin coating method. In that case, it is not necessary to use a sealing material. Thus, design, a kind of material, manner for mounting, and the like of various components of the first embodiment may be selected as far as it is within the scope of the present invention. Accordingly, alternative constitutions thus mentioned are deemed to be variations of the first embodiment of the present invention.

Further, the description was made about an example of a constitution in which the alignment of the liquid crystal molecules is changed by locating a pair of electrodes each shaped like the teeth of a comb on one of the substrates. The constitution for generating periodical refractive index distribution in a liquid crystal layer is not restricted to such the electrode. For example, a transparent electrode may be uniformly formed on surfaces of both the substrates between which the liquid crystal layer is interposed, and then pillar-shaped dielectrics may be located periodically between the both substrates. Such a constitution may be formed, for example, by the followings. Namely, a dielectric film is formed on a substrate on which a transparent electrode has been uniformly formed. The dielectric film is then patterned to be like paper tablets. The substrate is applied onto another substrate through spacers. At last, liquid crystal is injected to crevice of the dielectrics. Alternatively, two transparent substrates each of on which a transparent electrode is formed are applied to each other. A liquid crystal in which a liquid material, that will be hardened to be dielectrics by irradiating ultraviolet rays, is mixed is injected to crevice of the two transparent substrates. At last, using a mask having periodical openings like paper tablets, ultraviolet rays are irradiated onto the liquid material transmitting through one of the two transparent substrates to form the dielectrics. In any manufacturing processes, it is important to select the material in order that a refractive index of the pillar-shaped dielectrics may be corresponding with a refractive index of the liquid crystal against either a normal light or a abnormal light.

Functions required for the active-type diffraction element of the present invention are to control generation of the periodical refractive index distribution from the outside. In line with this, the active-type diffraction element can be constituted by using a material having any one of electro-optical (EO) effect, thermo-optical (TO) effect, acoustic-optical (AO) effect, and magneto-optical (MO) effect and control means for giving a physical input (electric field, heat, ultrasonic wave, magnetic field, respectively) to the material. For example, as a material having the EO effect, optical crystal, lithium niobate, and various polymer materials are known in addition to liquid crystal.

[Second Embodiment]—Multi Channel—

In the first embodiment, the incident light was only one light. However, in order to manufacture an optical device small in size and reduce the manufacturing cost thereof, a more desirable constitution is that pluralities of light are input to the device and respective light can be controlled independently. Namely, in the second embodiment of the present invention, pluralities of optical devices illustrated in FIG. 3 are arranged. Further, pluralities of incident light are controlled by the use of a common control circuit.

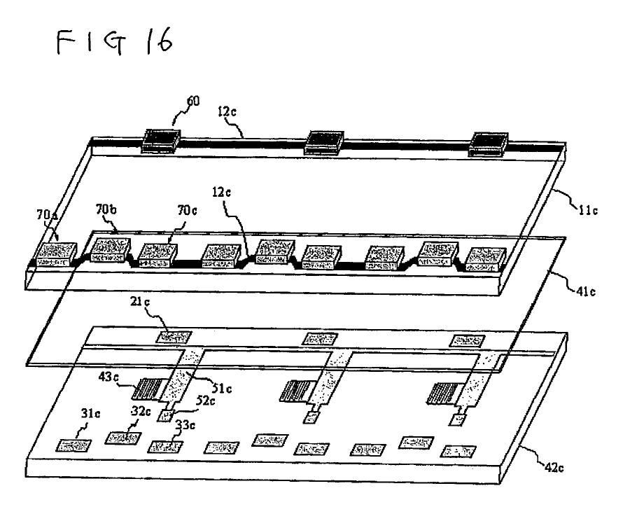

FIG. 14 is an explanation view for showing main components of the optical device according to the second embodiment of the present invention. FIG. 15 is an explanation view for showing a constitution of the common control circuit. As illustrated in an exploded perspective view of FIG. 14, the optical device comprises a transparent substrate 11b, a substrate 42b, and a liquid crystal 41b interposed between the substrate 42b and the transparent substrate 11b.

Herein, a plurality of light emitting elements 60 and light receiving elements 70a, 70b, 70c are mounted on an upper surface of the transparent substrate 11b. Wirings 12b for a plurality of light emitting elements 60 and light receiving elements 70a, 70b, 70c are formed on the transparent substrate 11b. Further, a plurality of diffraction elements 21b, 3b1, 32b, 33b, a plurality of electrodes 43b each shaped like the teeth of a comb, a control circuit 51b for independently controlling a voltage applied to a respective electrode 43b shaped like the teeth of a comb are formed on the upper surface of the substrate 42b. Moreover, although it is not shown in FIG. 12, alignment films for adjusting alignment direction of the liquid crystal are formed on a respective substrate, similarly to the case described in the first embodiment. Further, sealing materials having a liquid crystal injecting gate for injecting and sealing liquid crystal are previously formed on the alignment films. Next, these two substrates are applied to each other to be fixed on each other. A liquid crystal is then injected between the two substrates. A plurality of light emitting elements 60 and light receiving elements 70a, 70b, 70c are flip-chip mounted on the transparent substrate 11b to form the constitution of FIG. 12.

The control circuit 51b illustrated in FIG. 15 comprises a sift register circuit, a transistor Tr of which a gate electrode is connected to each output terminal CLM of the sift register circuit, a static capacitance C in which input signal DATA is stored by Tr, and a liquid crystal diffraction element DOE to which an electric potential stored by the static capacitance C is applied. The control circuit 51b can be formed on the transparent substrate, such as a glass substrate, a plastic substrate, and the like by a thin film transistor (TFT) using a polysilicon (poly-Si).

An operation of the optical device is described hereunder. With a condition that clock signals CLK1, CLK2 are continuously input to the sift register circuit, a start signal STRT is supplied to the sift register circuit. As a result, rectangular pulses are output from the output terminal CLM one by one from the end in the sift register circuit. At first, the output terminal CLM No. 1 becomes H level, Tr 1 then becomes ON. The input signal DATA at the time is stored in the static capacitance C No. 1. The liquid crystal diffraction element DOE No.1 generates optical characteristics in accordance with a voltage stored in the static capacitance C No. 1. Next, the output terminal CLM No. 1 becomes L level, and the adjacent output terminal CLM No. 2 becomes H level. After the adjacent output terminal CLM No. 2 becomes H level, similar operations are conducted. The liquid crystal diffraction element DOE No. 2 then generates optical characteristics in accordance with a voltage stored in the static capacitance C No. 2. These operations are repeated for all of the output terminals CLM. Thereby, optical characteristics of all of the liquid crystal diffraction elements DOE are determined. Herein, it is understood that each liquid crystal diffraction element DOE is independent and operable similarly to the liquid crystal diffraction element of the first embodiment. Thus, optical characteristics of all of the liquid crystal diffraction elements DOE can be determined desirably by writing the input signal DATA in the static capacitance C No. 1, C No. 2,. . . .

In FIG. 14, density for mounting respective liquid crystal diffraction element is restricted so that adjacent diffracted light may not be interfered with each other. This depends on factors, such as size, expansion of width, or the like of the incident light. However, it is, for example, readily possible that the liquid crystal diffraction elements are adjusted to be aligned at a pitch from 100 μm to 10 mm.

The remarkable feature of the second embodiment is that patterns of a plurality of electrodes 43b each shaped like the teeth of a comb are provided on a common transparent substrate and that liquid crystal is injected at the same time to be sealed in the common transparent substrate. It is thereby possible that optical connection elements are aligned with higher density than a structure in which a plurality of optical connection elements are mounted on a substrate independently. It is also advantageous that manufacturing cost per one channel can be reduced.

Further, in the second embodiment, a part of the control circuit is formed on the same transparent substrate by the use of TFT. A merit of the constitution is, at first, to make mounting be simple and small in size. If a plurality of the constitutions of FIG. 3 are simply arranged, it is necessary that the same numbers of pad portions as the numbers of liquid crystal diffraction elements exist and that each pad portion is one by one connected with an external printed substrate, and the like by a method of wire bonding, or the like. On the contrary, in the constitution illustrated in FIG. 14, numbers of pad portions for being connected with an external circuit are dramatically reduced. Reduction of numbers of connection improves reliability of connection. Second, a merit of the constitution is to make an optical device small in size and at a low cost. Namely, it becomes unnecessary that a control function mounted on the substrate by TFT is also provided in an external integrated circuit. A scale of the external integrated circuit is thereby reduced to make the optical device small in size and at a low cost.

Besides, it is not necessary that the liquid crystal diffraction elements are adjusted to be aligned at a certain pitch. The liquid crystal diffraction elements can be freely adjusted to be aligned, responsive to a use of the optical device. The feature of the second embodiment is to achieve advantageous effects of reduction of manufacturing cost, making the optical device smaller in size, and so on. Accordingly, these constitutions are deemed to be variations of the second embodiment.

[Third Embodiment]—Light Quantity Monitor—

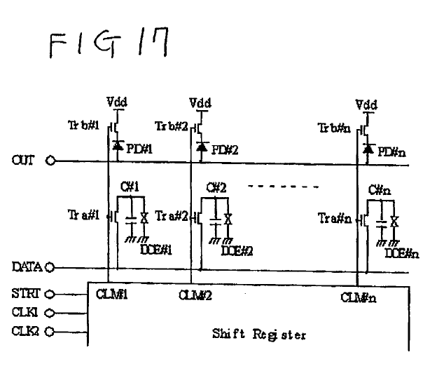

In the optical connection element and the optical device having the optical connection element thus described, quantity of light entered into the optical connection element or intensity of the diffracted light output therefrom may be varied. This is due to any factors that are different to be previously controlled, for example, like temperature characteristics of liquid crystal. If these quantity thus varied are detected and a voltage applied to liquid crystal is adjusted responsive thereto, the optical connection element independent from external variation factors and the optical device having the same can be provided. FIG. 16 shows an example of a constitution of an optical device having such a light quantity detecting function. The constitution of FIG. 16 is different from that of FIG. 14 in the points that a light quantity monitor 52c is provided and a control circuit 51c is designed accordingly.

First, the light quantity monitor 52c is located at a position that the light transmitted within the transparent substrate 11c reaches. The light quantity monitor 52c is, for example, an optical detector, such as a photo diode by amorphous silicon (a-Si) technique, and the like, and is formed on a surface of the transparent substrate 42c. Such photo diode alignments are generally used in a contact type image sensor by using amorphous silicon (a-Si). The photo diode alignments are well harmonized with manufacturing processes of thin film transistors by low temperature polysilicon technique. In other words, the circuit of FIG. 15 is manufactured on the transparent substrate similarly by using thin film semiconductor process for large area. Herein, an object that the light quantity monitor 52c detects can be diffracted light caused by the liquid crystal 41c above the electrodes 43c each shaped like the teeth of a comb or a transmitted light without being diffracted. Namely, since intensity of diffracted light or non-diffracted light is decided identically dependent on an applied voltage, diffracted light of any degrees can be detected by the light quantity monitor 52c.

Second, FIG. 17 is an explanation view for showing the constitution of the control circuit 51c. The constitution of FIG. 17 is different from that of FIG. 15 in the points that photo diode PD is connected to each output terminal of the sift register circuit through a transistor Trb, and that an output wiring OUT for detecting a current at the time of charging and discharging the photo diode PD connected to a power supply wiring Vdd is formed.

An operation of the optical device illustrated in FIG. 16 is described hereunder. At first, for example, an intensity of the first diffracted light is detected by the light quantity monitor 52c. The detection is completed as follows. For example, the output terminal CLM No. 1 of the sift register circuit becomes H level, the transistor Trb No. 1 then becomes ON. A current is thereby flown from the signal wiring OUT into the photo diode PD No. 1. An integrated value of the current is equal to a quantity of electric charge produced by irradiating light onto the photo diode during a certain period. Therefore, with the transistor Trb No. 1 being ON at certain intervals, a current flown in the signal wiring OUT during ON condition of the transistor Trb No. 1 is integrated by an amplification circuit (not shown). Thereby, a quantity of light having irradiated the photo diode PD No. 1 can be detected. As a result, a quantity of light having irradiated all of the photo diodes can also be detected by operating the sift register circuit thus mentioned. Next, a voltage applied to the electrodes 43c each shaped like the teeth of a comb is amended always or at certain intervals in order that an output of the light quantity monitor 52c may be a certain value.

Therefore, even if an intensity of diffracted light is varied due to any reason, stable operation can be obtained in the optical device by changing diffraction characteristics of the optical device based on the varied quantity thus detected. Consequently, the optical connection element independent from external variation factors and the optical device having the same can be provided.

Further, the same output of the sift register circuit is connected not only to a gate electrode of the transistor Trb No. 1a for writing a voltage into the liquid crystal diffraction element DOE No. 1 but also to a gate electrode of the transistor Trb No. 1b. With this structure, not only the writing of a voltage into the liquid crystal diffraction element DOE No. 1 but also output of the result of detection of intensity of the diffracted light corresponding to another voltage value written formerly can be carried out simultaneously. By co-owning the sift register circuit, the circuit scale can be reduced. As a result, manufacturing cost of the optical connection element can be reduced.

[Fourth Embodiment]—Variable Optical Attenuator (VOA)—

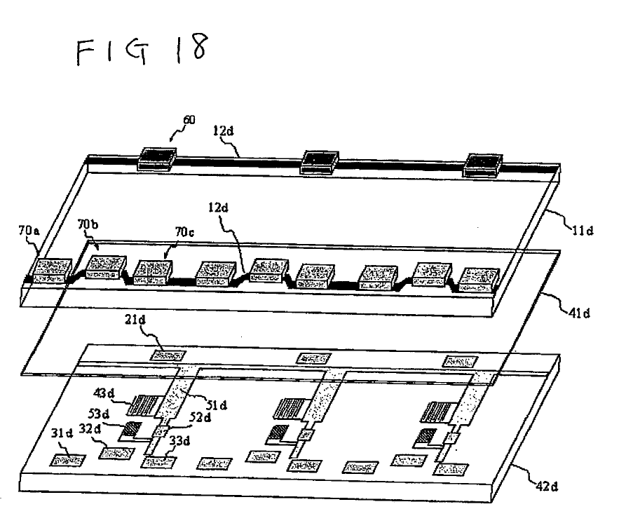

In the third embodiment, a power of the transmitted light is detected by the light quantity monitor and a voltage applied to the electrodes each shaped like the teeth of a comb is adjusted responsive thereto. Consequently, the optical device independent from external variation factors can be provided. On the other hand, an adjustable scope of the power of light is determined by a design of the liquid crystal diffraction element. Herein, by inserting a plurality of liquid crystal diffraction elements in series, it becomes possible that the adjustable scope of the power of light is enlarged drastically. FIG. 18 shows an example of constitution of an optical device including such a variable attenuating function of light quantity. The constitution of FIG. 18 is different from that of FIG. 16 in the points that the electrodes 53d each shaped like the teeth of a comb are provided and a control circuit 51d is designed accordingly.

First, the electrodes 53d each shaped like the teeth of a comb are located at positions that the light transmitted within the transparent substrate 11c reaches.

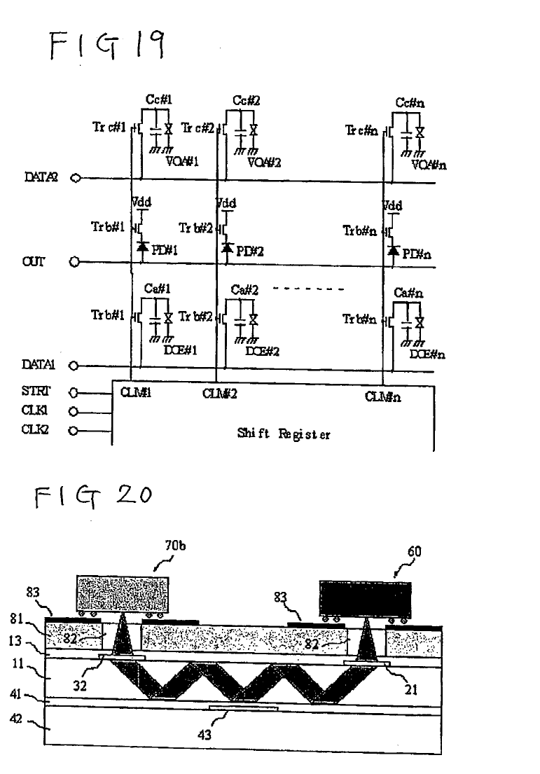

Second, FIG. 19 is an explanation view for showing the constitution of the control circuit 51d. The constitution of FIG. 19 is different from that of FIG. 17 in the points that variable optical attenuators (VOA) are connected to each output terminal of the sift register circuit through a transistor Trc, and that static capacitances Cc for keeping the characteristics of these VOA and an output wiring OUT2 for establishing a desirable characteristic in these VOA are formed. As illustrated in FIG. 19, the VOA is an equal circuit to the DOE. Both the VOA and the DOE are liquid crystal diffraction elements physically equal to each other.

An operation of the optical device illustrated in FIG. 18 is described hereunder. At first, similarly to that of the third embodiment, for example, an intensity of the first diffracted light is detected by the light quantity monitor 52d. A quantity of light having irradiated all of the photo diodes are detected. A voltage applied to the electrodes 43d each shaped like the teeth of a comb is amended always or at certain intervals in order that an output of the light quantity monitor 52d may be a certain value. At the same time, desirable voltage values are established in all of the VOA by way of the signal wiring DATA 2. Since each electrode 53d shaped like the teeth of a comb is inserted in each path for connecting the electrode 43d shaped like the teeth of a comb and each light receiving element 32d, light quantity reaching the light receiving element 70b is attenuated by diffraction of light caused by the electrode 53d. This result in that a variable scope of quantity of transmitted light is enlarged compared with the constitution of FIG. 16. For example, let the liquid crystal diffraction element of characteristics illustrated in FIG. 11 be formed by the electrode 43d shaped like the teeth of a comb and the electrode 53d shaped like the teeth of a comb. So, the maximum attenuating amount becomes approximately one thirty-sixth by forming such two stages of VOA, although the maximum attenuating amount was approximately one sixth by forming such one stage of VOA.

In the example of FIG. 18, the electrodes 53d each shaped like the teeth of a comb are located at a position that non-diffracted light reaches. A variable scope of a power of light reaching the light receiving element 32d is thereby enlarged. By changing the positions at which the electrodes 53d each shaped like the teeth of a comb are located, it is also possible that a variable scope of a power of light reaching the other light receiving elements is thereby enlarged. A variable scope of the light quantity can be more enlarged by inserting further a plurality of, namely, more than two stages of liquid crystal diffraction elements in series.

Herein, the same output of the sift register circuit is connected not only to a gate electrode of the transistor Tra for writing a voltage into the variable optical attenuator (VOA), a gate electrode of the transistor Trb for writing a voltage into the liquid crystal diffraction element (DOE), but also to the transistor Trb for reading a signal of light quantity monitor PD. With this structure, not only the writing of a voltage into the liquid crystal diffraction element DOE No. 1, output of the result of detection of intensity of the diffracted light corresponding to another voltage value written formerly, but also further attenuation of the transmitted light can be carried out simultaneously. By co-owning the sift register circuit, the circuit scale can be reduced. As a result, manufacturing cost of the optical connection element can be reduced.

[Fifth Embodiment]—Mounted on a Printed Substrate—

In the above embodiments, wirings are formed on one surface of the transparent substrate functioning as light guiding means. Further, light emitting elements and the light receiving elements are flip-chip mounted directly on the transparent substrate. However, dependent on kind of mounted elements or required performance of the optical device, conventional methods of mounting elements using a printed substrate can be alternatively used in the present invention. Especially, in a case that high density mounting by multilayer wiring is desired, such a method of mounting elements using a printed substrate is suitable. FIG. 20 is an explanation view for showing a section including main components and principles of operations in the optical device using such a method of mounting.

In FIG. 20, remarkable features are the points that light emitting element 60, and the like are flip-chip mounted on a printed substrate 81 in which openings 82 and wirings 83 are formed, and that a surface of the transparent substrate 11 facing the printed substrate 81 is overlaid by a layer 13 having a low refractive index. Herein, a material of the layer 13 having a low refractive index is selected so that the refractive index of the layer 13 having a low refractive index may be equal to a refractive index of liquid crystal 21 against normal light or smaller than the same. This is in view of conditions that light is totally reflected within the transparent substrate 11. Thereby, even if light is existing in a surface of the transparent substrate 11 facing the printed substrate 81, the light is transmitted within the transparent substrate 11 with no problem. It is decided by the liquid crystal 41 above the electrodes 43 each shaped like the teeth of a comb whether or not the light is diffracted, similarly to that of the first embodiment. Accordingly, functions of changing optical connection paths, adjusting light quantity, and the like can be realized similarly to those of the first embodiment.

Besides, instead of the total reflection, the light may be transmitted within the transparent substrate 11 by partial reflection on mirror surfaces. In this case, instead of the layer 13 having a low refractive index, materials each having high reflectivity, such as silver, aluminum, and the like are formed in positions that the light reaches.

FIG. 21 is an explanation view for showing main components located under the printed substrate 81 in the optical device of FIG. 20. As will be clearly understood from FIG. 21, the constitution of the fifth embodiment is different from that of the first embodiment also in the point that diffraction elements 21, 32, and so on are formed between the transparent substrate 11 and the layer 13 having a low refractive index. This is not an essential difference but showing that diffraction elements can be formed on a surface of the transparent substrate by changing design of the diffraction elements.

[Sixth Embodiment]—Micro Lens—

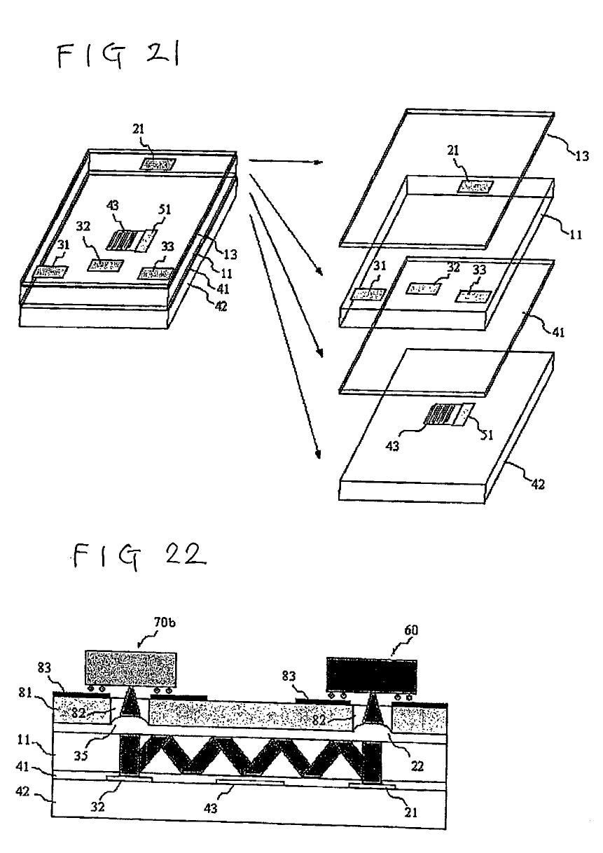

In FIG. 20, when a thickness of the printed substrate 81 is increased by the multilayer wiring, a distance between the light emitting element and the diffraction element is sometimes also increased. In this case, expansion of the light cannot be neglected. In such a case, a refraction element may be used to gather the light. FIG. 22 is an explanation view for showing a section including main components and principles of operations in the optical device having such a constitution. In FIG. 22, a remarkable feature is the point that a refraction element 22, a refraction element 35 are inserted between the light emitting element 60, the light receiving element 70b, respectively, and the transparent substrate 11. Besides, although depicted is a convex lens in FIG. 22, a plenary refraction element, such as one having refractive index distribution, Fresnel lens, or the like may also be used.

[Seventh Embodiment]—Mirror—

In the above embodiments, as optical means for inputting light from the light emitting element into light guiding means or for outputting the light to the light receiving element, input and output coupling by a diffraction element is used. The optical means having a function of input and output coupling are not restricted to a diffraction element. For example, a prism has conventionally been used for the purpose of input and output coupling. Therefore, light emitting elements illustrated in FIG. 4 or FIG. 20 may be mounted on an inclined surface of the prism to input light into the transparent substrate. It is, however, troublesome that the light emitting elements are flip-chip mounted on the inclined surface of the prism. This is because it is presumed that the light receiving or the light emitting elements input or output the light in perpendicular to a chip surface. Therefore, if such elements as inputting or outputting the light in an inclined direction can be developed, such a constitution using the prism would be favorable.

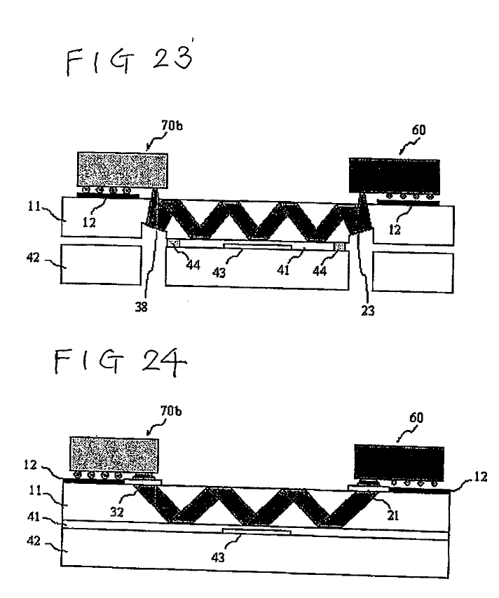

On the other hand, reflection elements may be used instead of the prism or the diffraction elements. FIG. 23 is an explanation view for showing a section including main components and principles of operations in the optical device using reflection elements as input and output coupling means. In FIG. 23, a remarkable feature is the point that a reflection element 23, a reflection element 38 are formed at the positions facing the light emitting element 60, the light receiving element 70b, respectively. Such reflection elements are formed by cutting a transparent substrate using a blade having an inclined plane and making surfaces of cut elements be mirror surfaces. Herein, it is necessary that the mirror surfaces are formed within the transparent substrate 11. Therefore, the position of the sealing material 44 needs to be previously located as shown in FIG. 23 in order that the liquid crystal layer may not be leaked to the outside at the time of cutting the transparent substrate 11.

[Eighth Embodiment]—Positions of Diffraction Elements—

As has already been clear from the above embodiments, positions at which diffraction elements used as input and output coupling means are located may be either above and under the transparent substrate used as light guiding means. Namely, the diffraction elements in FIGS. 4 and 22 are located under the transparent substrate while the diffraction elements in FIG. 20 are located above the transparent substrate. This is a design matter having no relation with a viewpoint whether or not the printed substrate is used. Accordingly, FIG. 24 shows, as an eighth embodiment of the present invention, the remaining combination, that is, a constitution in which light emitting elements, and the like are mounted on a transparent substrate and the diffraction elements are formed above the transparent substrate. Operations of the optical device in FIG. 24 are similar to those of the above embodiments.

The present invention brings the following advantageous effects compared with a conventional optical connection element capable of changing connection paths.

First, it is necessary to irradiate a control light on a non-linear mirror to alter the connection paths of light. It therefore becomes necessary to prepare a source of light and control means for irradiating the control light. As a result, not only cost for manufacturing the optical connection device but also volume of the optical connection device are thereby increased. On the other hand, diffraction/branching means composed of a material having EO effect are used, as described in the first embodiment of the present invention. As a result, not only cost for manufacturing the optical connection device but also volume of the optical connection device can be reduced.

Second, as described in the first embodiment, light is shut within the light guiding means in the optical connection element according to the first embodiment of the present invention, even if the connection path is changed. As a result, the optical connection element can be readily smaller in size, when the optical connection element is applied to various optical devices.

Third, as described in the second embodiment, patterns of a plurality of transparent electrodes are provided on a common transparent substrate and liquid crystal is injected at the same time to be sealed in the common transparent substrate. It is thereby possible that optical connection elements are aligned with higher density than a conventional structure in which a plurality of optical connection elements are mounted on a substrate independently. As a result, various multi-channel optical devices can be readily smaller in size. It is also advantageous that manufacturing cost per one channel can be reduced.

Fourth, as described in the second embodiment, a part of the control circuit is formed on the same transparent substrate by the use of TFT. Numbers of electrical connection to the external circuit can thereby be reduced drastically. A scale of the external integrated circuit is thereby reduced to make the optical device small in size and at a low cost.

Fifth, by applying the optical connection element of the present invention, various optical devices, such as a variable optical attenuator, a polaroid isolator (separation filter), an optical switch, a filter, and the like can be constructed. Since the optical connection element of the present invention has meritorious effects mentioned above, the various optical devices can be readily smaller in size and at a lower cost, when the optical connection element is applied to the various optical devices.

Sixth, a constitution of the present invention has means for detecting an intensity of the diffracted light, a voltage applied to the diffraction element is amended always or at certain intervals in order that the intensity of the diffracted light may be a certain value. Therefore, even if an intensity of diffracted light is varied due to any reason, stable operation can be obtained in the optical device by changing diffraction characteristics of the optical device based on the varied quantity thus detected. Consequently, the optical connection element independent from external variation factors and the optical device having the same can be provided.

Seventh, light detecting means are formed on the same substrate on which diffraction elements are formed by using manufacturing processes of thin film transistors. Consequently, the optical connection element independent from external variation factors and the optical device having the same can be provided without increasing numbers of parts, cost of members, labor for assembly.

What is claimed is:

1. An optical connection element which is for use in optically connecting LSI chips to each other or modules including many LSI chips mounted thereon to each other, comprising:
light guiding means which is capable of propagating light in a plurality of directions;
input coupling means for inputting light from the outside to said light guiding means;
output coupling means for outputting light from said light guiding means to the outside;
active-type optical means which is located in a path for transmitting light within said light guiding means; and
control means which is capable of altering characteristics of said active-type optical means.

2. An optical connection element as claimed in claim 1, wherein said active-type optical means is an active-type diffraction element including both a material having an opto-electrical effect and an electrode, said active-type optical means performing at least one function among said functions of optical branching, attenuation, separation of wave-length, and separation of polarization of light in response to an electric signal supplied from said control means.

3. An optical connection element as claimed in claim 2, wherein said light guiding means is a transparent substrate, said active-type diffraction element having a liquid crystal located between a substrate and said transparent substrate.

4. An optical connection element as claimed in claim 3, wherein said electrode has a shape like a pair of combs, said electrode being located in a surface of at least one of said substrate and said transparent substrate, said surface facing to said liquid crystal.

5. An optical connection element as claimed in claim 3, wherein said electrode comprises a group of a plurality of periodically arranged electrode members, said electrode being located in a surface of at least one of said substrate and said transparent substrate, said surface facing to said liquid crystal.

6. An optical connection element as claimed in claim 3, wherein said electrode is located uniformly in a surface of at least one of said substrate and said transparent substrate, said surface facing to said liquid crystal, a plurality of dielectrics being periodically located on or within said liquid crystal.

7. An optical connection element as claimed in claim 1, wherein said control means comprises a circuit element including a thin-film transistor in a surface of said transparent substrate, said surface facing to said liquid crystal.

8. An optical connection element as claimed in claim 1, wherein at least one of said input coupling means and said output coupling means is composed of a diffraction element or a reflection element located within said light guiding means.

9. An optical device comprising:
at least one light emitting element;
a plurality of light receiving elements; and
an optical connection element;
said optical connection element including:
light guiding means which is capable of propagating light in a plurality of directions;
input coupling means for inputting light from the outside to said light guiding means;
output coupling means for outputting light from said light guiding means to the outside;
active-type optical means which is located in a path for transmitting light within said light guiding means; and
control means which is capable of altering characteristics of said active-type optical means.

10. An optical device as claimed in claim 9, wherein said light guiding means is a transparent substrate, at least either one of said light emitting element and said light receiving elements are flip-chip mounted on said transparent substrate.

11. An optical device as claimed in claim 9, wherein said light emitting element and said light receiving elements are flip-chip mounted on a printed substrate having a plurality of openings, a light from said light emitting element being lead to said input coupling means through said a plurality of openings while a light from said output coupling means being lead to said light receiving elements through said a plurality of openings.

12. An optical device as claimed in claim 9, wherein refraction elements each having a light gathering function are located between said light emitting element and said input coupling means, between said output coupling means and said light receiving elements, respectively.

13. An optical device as claimed in claim 9, wherein light quantity detecting means for monitoring quantity of light transmitted within said light guiding means are located in said path for transmitting light within said light guiding means.

14. An optical device as claimed in claim 13, wherein said light quantity detecting means is a light receiving element including an amorphous silicon material.
